(19) United States
(12) Patent Application Publication
(10) Pub. No.: US 2019/0375440 A1
(43) Pub. Date: Dec. 12, 2019

(54) METHOD FOR PRIORITIZING RAILWAY CROSSING FLOWS, AND MEMORY STORAGE MEDIUM

(71) Applicant: Vale S.A., Rio de Janeiro (BR)

(72) Inventors: Nikolas Jorge SANTIAGO CARNEIRO, Belem (BR); Jorge Manuel FILIPE DOS SANTOS, Belem (BR); Sérgio Ivan VIADEMONTE DA ROSA, Porto Alegre (BR); Cleidson Ronald BOTELHO DE SOUZA, Belem (BR); José Aroudo MOTA, Belem (BR)

(21) Appl. No.: 16/436,646

(22) Filed: Jun. 10, 2019

(30) Foreign Application Priority Data
Jun. 11, 2018 (BR) 10 2018 011744 0

(51) Int. Cl. B61L 25/08; B61L 23/00; G06Q 10/04; G06F 16/901

(52) U.S. Cl. CPC B61L 25/08; G06F 16/9024; G06Q 10/04; B61L 23/002

(57) ABSTRACT

The present aspects refer to a method for prioritizing railway crossing flows comprising: defining residence location nodes, daily-activity location nodes and level crossing nodes within a zone of influence; generating a graph comprising the residence location nodes, daily-activity location nodes and level crossing nodes and a set of edges, wherein said edges connect the residence location nodes, daily-activity location nodes and level crossing nodes, generating a connected component containing residence location nodes, daily-activity location nodes and level crossing nodes; and obtaining a vector comprising the level crossing nodes in descending order of the value assigned to each level crossing node. The present aspects also refer to a memory storage medium comprising computer-executable instructions for implementing a method for prioritizing railway crossing flows.

### CROSS-REFERENCE TO RELATED APPLICATIONS

This application claims priority to Brazilian Patent Application No. BR 10 2018 011744 0, filed Jun. 11, 2018, the disclosure of which is incorporated in its entirety herein by reference.

### TECHNICAL FIELD

This invention relates to the field of rail traffic safety. More specifically, this invention relates to a method for prioritizing railway crossing flows and a memory storage medium.

### BACKGROUND

The crossing flows along a railway do not always correspond to intersections officially recognized by the institutions that operate the railway system. In some circumstances, communities living along railways may establish alternative crossing points. This is particularly important in areas of low levels of human development where socio-economic vulnerability is reflected in the interactions between the daily lives of the population and the operations of the railway system.

In areas with low level of development, such as peripheral regions of urban areas, the daily railway crossing flows occur through the official local railway system, such as level crossings established by the system operator, or non-official ones, such as alternative roads, trails and crossings.

In the case of rural areas, the dispersed settlement pattern and the typical distances between places of productive activity and residence locations induce daily flows of individuals that are often accomplished by walking, cycling or with the use of motorcycle. Part of this flow is also comprised of livestock daily displaced to areas of pasture or watering. The flows may involve cargo displacement, and it will possibly occur in animal-drawn vehicles.

It is in this context that crossings of individuals in railway lines take place. Such displacements are substantially done through officially marked intersections, whose existence leads to a definition of specific safety procedures for the railway operation, such as sound signals, speed reduction, gates, etc.

However, a considerable part of the crossing of individuals occurring in the environments described above takes place through non-official crossings in which there is no signaling and, therefore, are not duly safe. It should also be noted that crossings, even if carried out at official intersections, such as level crossings, could result in road crashes or collisions with road vehicles, which affect the life of communities and the operation of the railway.

Some solutions related to rail traffic planning methods and systems are already found in the state of the art. Specifically, Liebchen, C., in “The First Optimized Railway Timetable in Practice”—Transportation Science 42(4), pp. 420-435, 2008, discloses a method for optimizing schedules of railway lines. The method taught in this document is based on a graph model called “periodic event-scheduling problem” and is applied to the schedule of the Berlin subway lines in order to minimize operating costs and optimize the quality level.

Carmo, MRR, Netto, POB, and Portugal, L. S., in “Uma heuristica interativa para geração de caminhos em grafos com restriçäo de gran: aplicaçäo ao projeto de sistemas metroviários”—Pesquisa Operacional, v. 22, n. 1, p. 9-36, January-June 2002, disclose a methodology for designing a subway network through a graph model, in which the vertices are stations joined by stretches of lines represented by edges. These heuristics, which generate lines, aim at generating lines that minimize the total cost of construction, looking for paths of lower cost between peripheral vertices.

In “Graph Theory Approach to Transportation Systems Design and Optimization”—International Journal on Marine Navigation and Safety of Sea Transportation, v. 8, n. 4, 2014, Guze, S. discloses graph theory parameters and algorithms as tools for analyzing and optimizing transport systems, for example, railway networks, airports, ports and systems for the generation, transmission and distribution of electricity. Procedures for finding the minimum spanning tree in graphs, such as the Kruskal algorithm and the Prim algorithm, are shown.

U.S. Pat. No. 9,260,123 (B2) discloses a system and a method for determining the position of a locomotive. For this determination, the controller revealed by this document uses a Prim's algorithm to determine the minimum spanning tree of a graph that specifies the order of the locomotives within a consist.

Thus, there is a need for a method to prioritize crossings of a railway that considers the official and non-official crossing points and flows of people through these locations.

### SUMMARY OF THE INVENTION

This invention aims to provide a method for prioritizing railway crossing flows that considers the residence location, the daily-activity locations and the level crossings for the identification of such flows.

This invention also aims to provide a memory storage medium comprising computer-executable instructions that implement a method for prioritizing railway crossing flows that considers the residence location, the daily-activity locations and level crossings for the identification of such flows.

The present invention relates to a method for prioritizing railway crossing flows comprising the following steps:
defming residence location nodes, daily-activity location nodes and level crossings nodes within a zone of influence;
generating a graph comprising the residence location nodes, the daily-activity location nodes, the level crossing nodes and a set of edges, wherein said edges connect the residence location nodes, the daily-activity location nodes, and the level crossing nodes;
generating a connected component comprising residence location nodes, daily-activity location nodes, and level crossing nodes, wherein generating a connected component comprises:
   a) randomly defining one of the level crossing nodes as the root of a maximum spanning tree and adding said level crossing node to the connected component;
   b) selecting the edge of the graph that is not in the connected component that has greater flow and is connected to any one of the nodes added in the connected component provided that said edge:
   b.1) connects to a node that is not yet in the connected component and
   b.2) is not connected to a level crossing node other than that defined in item a);
   c) including the edge defined in item b) in the connected component;
   d) including the node of item b.1) in the connected component;
   e) repeating the steps b), c) and d) until all reachable nodes of the graph are included in the connected component;
   f) adding the flow value of all the edges of the maximum spanning tree formed from the root level crossing node, and assigning said value to the level crossing node; and
   g) repeating steps a) to f) for all level crossing nodes;
obtaining a vector comprising the level crossing nodes in descending order of the value attributed to each level crossing node.

This invention also refers to a memory in communication with a processor configured to execute the disclosed methods, and a memory storage medium comprising computer-executable instructions for implementing the disclosed methods for prioritizing railway crossing flows.

### BRIEF DESCRIPTION OF THE DRAWINGS

The invention will now be described with reference to the accompanying drawings, given by way of example of possible forms of implementation of the method under consideration:

FIG. 1—Example of a graph comprising residence locations, daily-activity locations and identified level crossings and edges valued according to the flow of individuals;

FIG. 2—Another example of a graph comprising residence locations, daily-activity locations and identified level crossings and edges valued according to the flow of individuals;

FIG. 3—Example of generating a spanning tree for a first level crossing;

FIG. 4—Example of generating a spanning tree for a second level crossing;

FIGS. 5 and 6—Flowcharts illustrating a method for prioritizing railway crossing flows.

The figures are illustrative. The number of residence locations, daily-activity locations and level crossings used in the method of this invention are not limited to the amounts described in the figures. The method applies to any number of nodes.

### DETAILED DESCRIPTION

The following description will depart from a preferred embodiment of the invention, applied to a method for prioritizing railway crossing flows and a memory storage medium.

The present invention presents a method for prioritizing railway crossing flows comprising the following steps:
defming residence location nodes, daily-activity location nodes and level crossing nodes within a zone of influence;
generating a graph comprising the residence location nodes, the daily-activity location nodes, the level crossing nodes and a set of edges, wherein said edges connect the residence location nodes, the daily-activity location nodes, and the level crossing nodes;
generating a connected component comprising the residence location nodes, the daily-activity location nodes, and the level crossing nodes, wherein generating a connected component comprises:
   a) randomly defining one of the level crossing nodes as the root of a maximum spanning tree and adding said level crossing node to the connected component;
   b) selecting the edge of the graph that is not in the connected component that has greater flow and is connected to any one of the nodes added in the connected component provided that said edge:
   b.1) connects to a node that is not yet in the connected component and
   b.2) is not connected to a level crossing node other than that defined in item a);
   c) including the edge defined in item b) in the connected component;
   d) including the node of item b.1) in the connected component;
   e) repeating the steps b), c) and d) until all nodes of the graph are included in the connected component;
   f) adding the flow value of all the edges of the maximum spanning tree formed from the root level crossing node, and assigning said value to the level crossing node; and
   g) repeating steps a) to f) for all level crossing nodes;
obtaining a vector comprising the level crossing nodes in descending order of the value attributed to each level crossing node.

This invention also refers to a memory storage medium comprising computer-executable instructions for implementing a method for prioritizing a railway crossing flows. Said computer-executable instructions can be implemented in many ways, including the use of programming languages such as Java, C ++, Python, Swift, among others.

The method of this invention may be implemented in any type of hardware configuration, operating system, and programming language, considering the size of the problem to be solved, and not to the method itself (by size of problem, it means the amount of daily-activity locations, residence locations and level crossings, in a specific implementation). For example, the method can be implemented in hardware configurations such as Macbook Pro (OS X operating system, Intel Xeon E5 processor with 3.5 GHz, 64 GB 1866 MHz memory RAM), iPad Pro 9.7″, 32 GBytes RAM, desktop or notebook (Windows V8 or later operating system, 4 GB RAM, HD, or Linux operating system, 4 GB RAM), among others.

The steps of the method of this invention will be described below.

### Definition of Residence Locations, Daily-Activity Locations and Level Crossings in the Surroundings of the Railway Track

The crossing flows of this invention are generated through the circulation of individuals between residence locations, such as residences, accommodation buildings and lodgings, and daily-activity locations, which are places where such individuals perform activities such as work, study, coexistence, and commerce, and railway level crossings are all railway crossings, both officially and non-officially established.

Preferably, the identification of the crossing flows in this invention is made from geographic information, such as geographical coordinates, that is, latitude and longitude, or address of residence locations and daily-activity locations. The level crossings are also identified in the present invention from geographic information, such as its geographical coordinates, or the position, for example in kilometers, where such crossings are placed in the railway line.

In order to delimit the area of influence, that is, the geographic region of interest, which comprises a railway and the communities around it, it is necessary to define for each community the areas in which there are residence locations and daily-activity locations that can generate flows of individuals and/or goods. This zone of influence will be the zone for which the crossing flows will be identified.

Preferably, a system user defines the residence location data, the daily-activity location data and the level crossing data, based on the geographical location thereof Alternatively, nearby residence locations may be treated as a single residence location if locomotion between such residence locations is not costly in relation to the railway. In another alternative embodiment of this invention, residence location data, daily-activity location data, and level crossing data are automatically reported to the proposed system by querying existing databases, remote sensing operations, image analysis, among other possibilities.

Alternatively, there can be defined local community insertion areas, which include the residence locations related to that community and the daily-activity locations in its neighborhood, where people normally access without needing transportation. Furthermore, a zone of direct socioeconomic influence can be defined and it contains institutions outside the neighborhood of the community under consideration that bring a significant number of individuals of that community. Examples of these institutions are factories, stores, schools, churches, farms, among others. In addition, several different zones of direct socioeconomic influence may be defined in the present invention. Preferably, a system user will perform the determination of these zones of direct socioeconomic influence.

### Generation of the Graph Representing the Network of Crossing Flows

The method used in this invention provides the generation of a graph to represent the network of crossing flows through a railway. Preferably, said graph may consider zones in which the railway has two or three tracks, as well as other data of each zone such as frequency of pedestrian crossing, speed of the railway vehicle, among others.

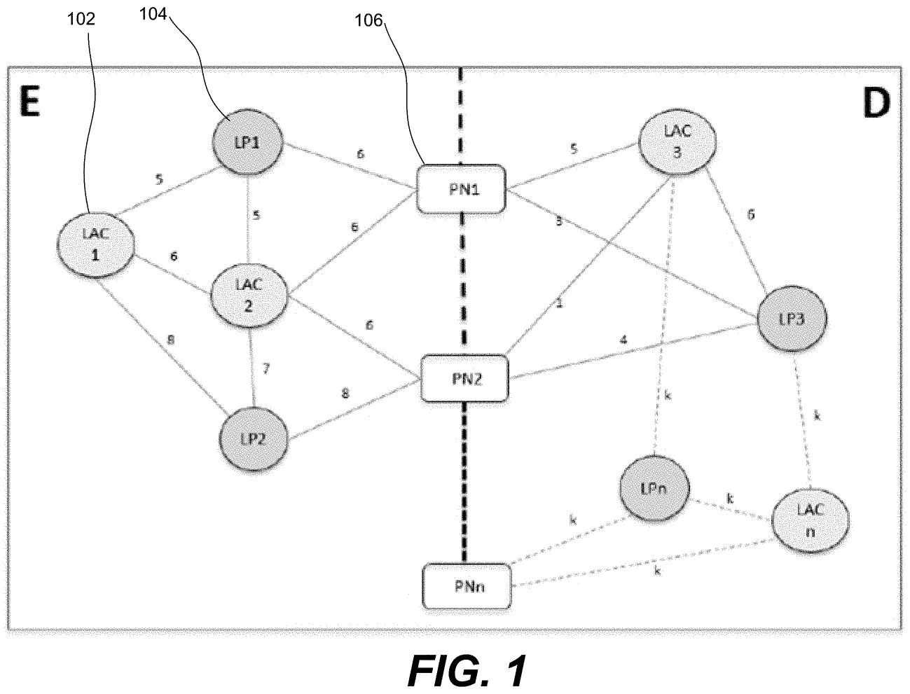

FIG. 1 illustrates a schematic graph, wherein each residence location 104 LP1, LP2, LP3, LPn or each daily-activity location 102 LAC1, LAC2, LAC3, LACn is represented by a respective node of said graph. FIG. 1 also illustrates that the method for prioritizing railway crossing flows of the present invention is not limited to a specific amount of residence locations, daily-activity locations and level crossings. The element indices vary in the interval [1, . . . , n], wherein n is the maximum number of elements. The broken lines, which connect nodes of index equal to n, also indicate the existence of other elements (residence locations, daily-activity locations and level crossings).

Alternatively, in situations wherein the residence locations LP1, LP2, LP3, LPn comprise, for example, an accumulation of buildings, the geometric center of the surrounding polygon can be used to represent that residence location through a single node. Analogously, the daily-activity locations LAC1, LAC2, LAC3, LACn are represented by nodes. In addition, a single daily-activity location node LAC1, LAC2, LAC3, LACn may represent a school, a hospital, or even a neighborhood.

The residence location nodes LP1, LP2, LP3, LPn and daily-activity location nodes LAC1, LAC2, LAC3, LACn are grouped into two disjoint sets provided by a cut in the graph, determined by the railway contour,. that is, assuming an orientation to the railway, starting from a starting point to an end point. A first disjoint set comprises a mixed group of nodes formed by residence location nodes and daily-activity location nodes positioned on the left side E of the railway, while the second disjoint set comprises a mixed group of nodes positioned on the right-side D of the railway. In this embodiment, the nodes are marked with the disjoint set (to the side) to which they belong.

The level crossings 106 PN1, PN2, PNn are also modeled as nodes of the graph. The level crossing nodes PN1, PN2, PNn form a third disjoint set wherein said nodes are positioned on the railway.

The graph generated in this invention also comprises edges representing the different access paths between the residence locations LP1, LP2, LP3, LPn and the daily-activity locations LAC1, LAC2, LAC3, LACn. Thus, preferably, in a given zone of influence, an edge of each residence location node LP1, LP2, LP3, LPn will be created for each daily-activity location node LAC1, LAC2, LAC3, LACn, or even between residence location nodes or between daily-activity location nodes, in case these flows are of some influence for the railway crossing, respecting the existing access routes. These access routes can be official like roads, highways and streets, or non-official, like trails and other alternative paths created by the individuals living in the communities around the railway.

In a preferential embodiment, if a residence location node and a daily-activity location node are on the same side of the railway, then an edge connects these two nodes. If a residence location node and a daily-activity location node are on different sides of the railway, then two different edges are created and each of these edges must connect the residence locations and the daily-activity locations to the level crossings existing in the zone of influence under consideration. The created edges should preferably connect the nodes respecting the existing access paths. In this way, the edges are designed to model the flows of individuals in transit from their homes to their jobs, schools, hospitals, etc. The edges of the graph shall not be directed.

The graph of the present invention, used for the modeling of the zone of influence, is preferably a connected, non-directed and valued graph, whose nodes are divided into two sets by a cut that is defined by the railway track. Each residence location node LP1, LP2, LP3, LPn, or each daily-activity location node LAC1, LAC2, LAC3, LACn, may have an associated value. In a preferential embodiment, this value is informed by a system user. Alternatively, this value may be computed automatically by the system of the present invention. This value associated to each residence location node or daily-activity location node can represent the population that uses the respective residence locations or daily-activity locations. For example, the value of each residence location node may represent the number of residents of a neighborhood or the number of beds in a particular hospital in the case of a daily-activity location. This value is unique for each node and can alternatively be computed through a function that takes several parameters of the residence locations or the daily-activity locations under consideration. Examples of parameters that can be used include number of residents, number of beds, average human development index (HDI), average income, average schooling rate, average alcoholism rate, etc. In alternative embodiments of the present invention, the method comprises different equations and parameters for calculating this value assigned to each residence location node or daily-activity location node.

The edges of the graph generated by this invention represent the tracks that interconnect the nodes, and the values of these nodes relate to the flow and/or distance information in those tracks and they are assigned to the edge. That is, preferably, the flow of individuals along this track or the distance between two nodes, or even a function of these two information, represents the weight of the edges. In an alternative embodiment of the present invention, different graphs may be generated. The difference between such graphs is, for example, the weight assigned to the edges, that is, the nodes and edges will be the same. It allows, for example, to model different moments in time, such as morning, evening and night flows, which are typically different. In another alternative embodiment, it is assumed that the different flows of the various edges are unknown, considering an equal flow for all the edges.

Generation of a Connected Component from the Nodes of Residence Location, Daily-Activity Locations and Level Crossings

After defining the values of the elements of the graph, that is, residence locations LP1, LP2, LP3, LPn, daily-activity locations LAC1, LAC3, LAC3, LACn and edges, it must be identified which one of the level crossings PN1, PN2, PNn is the one that has the greatest potential flow for crossings. In addition, it is also possible to evaluate and define the best structure of tracks that use the level crossing PN1, PN2, PNn with the greatest potential flow, for example, to propose actions at this level crossing or the associated tracks in order to improve the safety of that crossing. To this end, the method of the present invention comprises the generation of a connected component in order to generate a spanning tree. Preferably, the Kruskal algorithm or a Kruskal algorithm adapted to select higher value edges is used for generating the spanning tree.

Specifically, for each level crossing PN1, PN2, PNn, a spanning tree is generated considering each level crossing PN1, PN2, PNn as the root or starting point of said spanning tree, and the edges of each side of the railway cut that are connected to other level crossings are ignored.

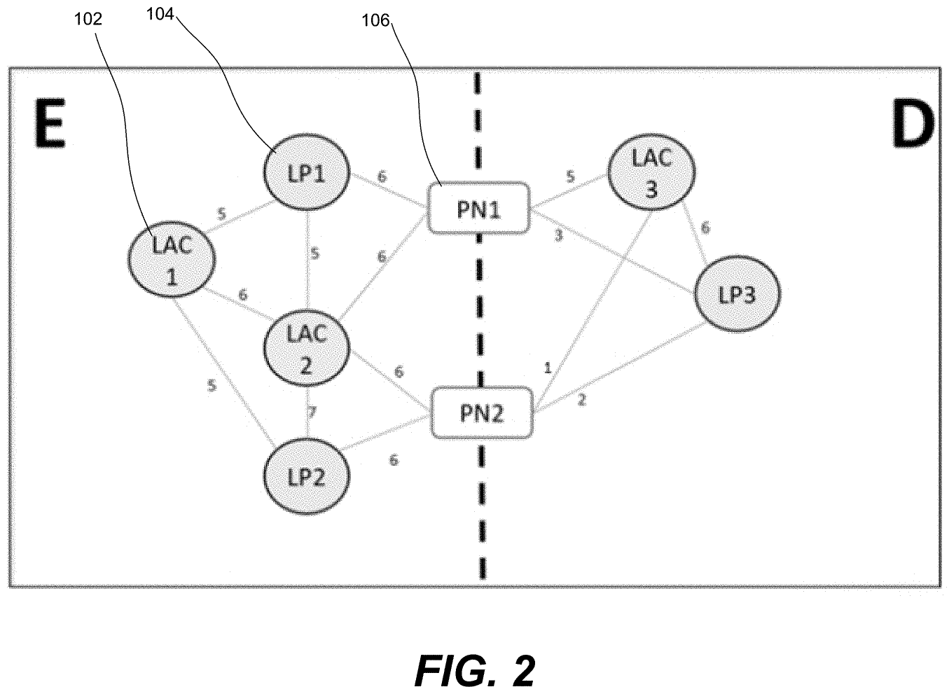

FIGS. 2, 3 and 4 show an example of embodiment in which the graph comprises two level crossings PN1, PN2, three daily-activity locations LAC1, LAC2, LAC3 and three residence locations LP1, LP2, LP3. In other words, FIGS. 2, 3 and 4 show indices from 1 to 3 for the daily-activity locations and residence locations and indices 1 and 2 for the level crossings, representing the quantities of elements in this specific embodiment.

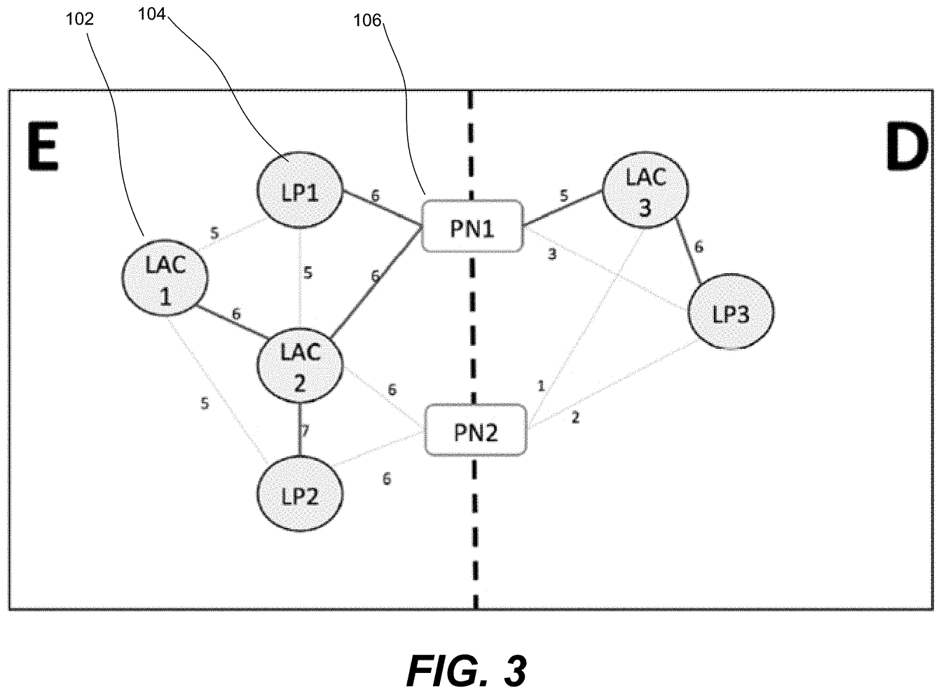

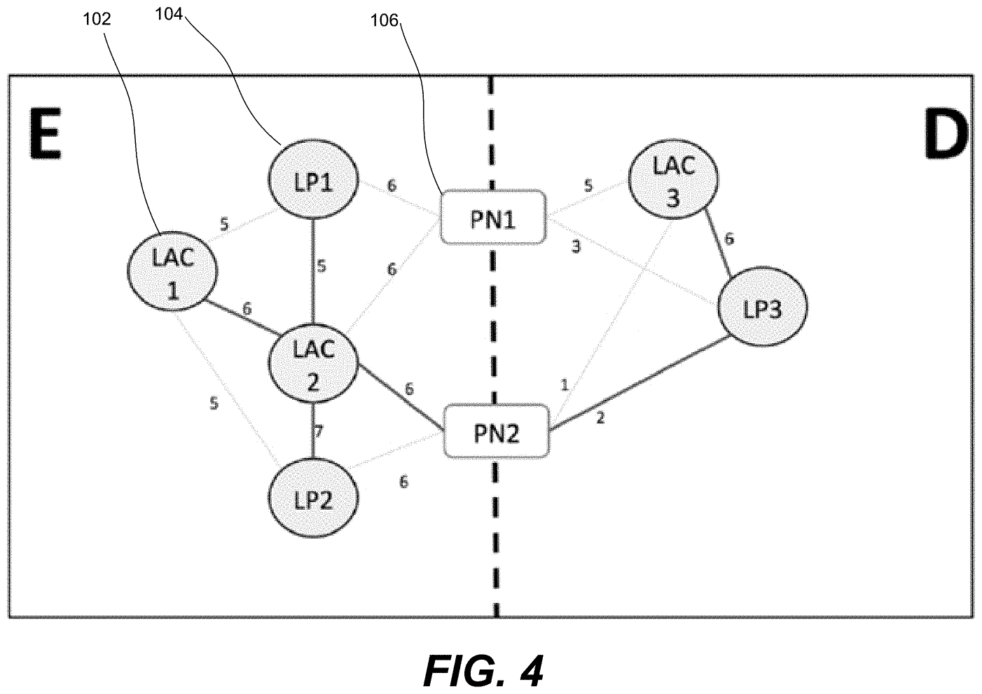

FIG. 3 shows the generation of a spanning tree for a first level crossing PN1 and FIG. 4 shows the generation of a spanning tree for a second level crossing PN2. Thus, this spanning tree indicates the tracks that connect all the reachable nodes of that side of the railway to the level crossing of greater potential flow, based on the most popular tracks, according to the metric used in the evaluation of the edges. In addition, this procedure is performed for the other level crossings in the zone of influence under consideration, which allows comparing such level crossings in relation to which of them meet more satisfactorily the needs of the individuals that cross the railway.

Alternatively, the flow value of each of the edges is defined by the average flow value of individuals between two nodes.

### Classification of Priority Crossings

In the present invention, the assigned values for each level crossing PN1, PN2, PNn represent the flow associated with each of those level crossings, which can relate to a risk associated with that PN. Preferably, this risk considers the relevant features of each level crossing, such as the presence of a duplicate or even triplicate track of the railway, and other factors that may affect the risk of each level crossing, such as reduced visibility, the train parking area and climate sensitivity (rain, ice, etc.).

From the sum of the values of the edges of each spanning tree, a value is assigned for each level crossing PN1, PN2, PNn, wherein the highest value indicates the level crossing with the highest potential flow and consequently of higher priority.

In this regard, the method of the present invention comprises obtaining a vector including the level crossing nodes PN1, PN2, PNn, arranged in descending order of the value assigned to each level crossing, wherein the first level crossing of this vector, as well as the tracks that integrate its spanning tree, have a higher priority, whether it is in new investments, repairs and others in relation to the second, which in turn must be prioritized in relation to the third and so on consecutively.

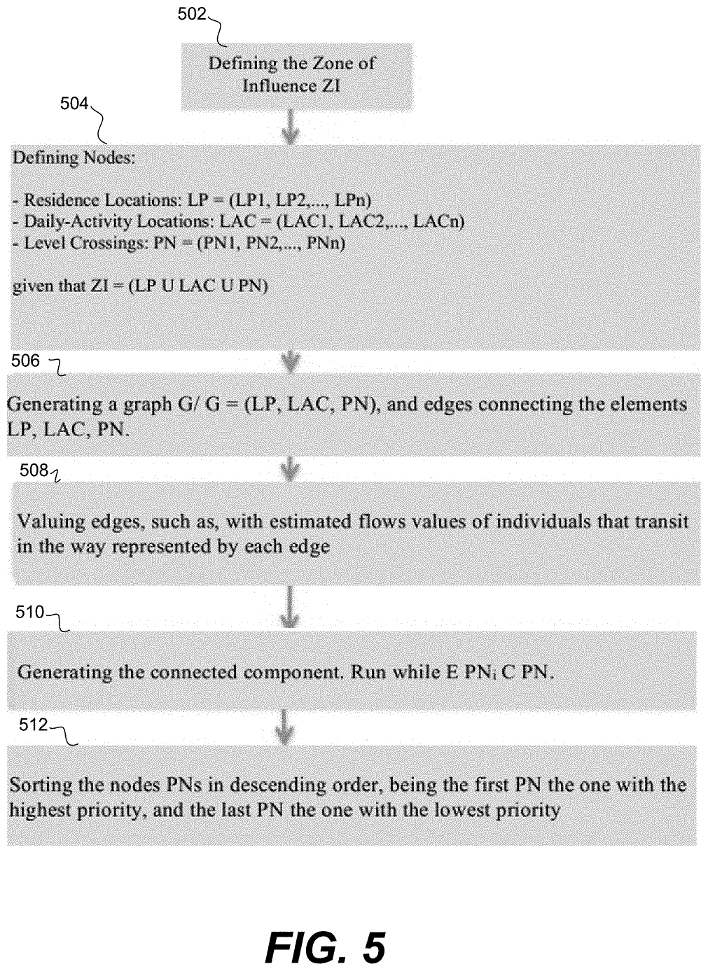

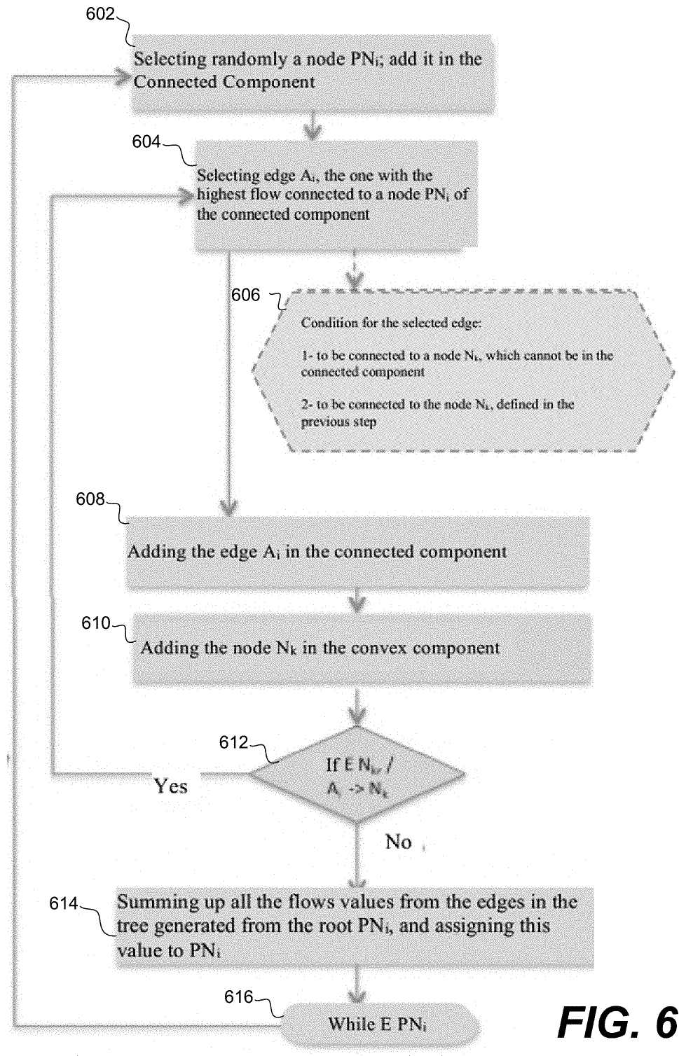

FIG. 5 shows the prioritization of crossings of a railway. At 504 and 504 a zone of influence comprising residence locations, daily-activity locations and level crossings is defined. At 506 a graph comprising edges that connect the residence locations, the daily-activity locations and the level crossings is generated. At 508 the edges are valued, for example by the estimated flow value of individuals using the track represented by each edge. At 510 a connected component is generated (further described with reference to FIG. 6 below) and at 512 the level crossing nodes are sorted in decreasing order, the first level crossing being the one with the highest priority and the last level crossing the one with the lowest priority.

In FIG. 6, at 602 selecting randomly a node PNi; add it in the connected component. At 604 selecting edge Ai, the one with the highest flow connected to a node PNi of the connected component. At 606 the condition for the selected edge: 1—to be connected to a node Ni, which cannot be in the connected component; 2—to be connected to the node Ni, defined in the previous step. At 608 adding the edge Ai in the connected component. At 610 adding the node Nk in the convex component. At 612 repeating 604, 606, 608, 610 until all reachable nodes of the graph are included in the connected component. At 614 summing up all the flow values from the edges in the tree generated from the root PNi, and assigning this value to PNi. At 616 repeating 602, 604, 608, 610, 612, 614 for all level crossing nodes.

Thus, the present invention solves the technical problem of prioritizing crossings of a railway. To this end, this invention provides a method that models the railway and its surroundings through graphs and that quantifies a priority relationship of level crossings, associated with a variable of interest, such as the flow of individuals.

In addition, this invention has the advantage of considering the peculiarities of each zone of interest in prioritizing the level crossings in these zones. This allows the realization of a planning of the railway system that meets the needs of the individuals who live in areas near the railway.

It is reinforced that the present invention is not limited to the configurations/embodiments described above. Furthermore, this invention is not limited to any programming language, nor to any specific hardware configuration.

1. A method for prioritizing railway crossing flows, comprising:
defining residence location nodes, daily-activity location nodes, and level crossing nodes within a zone of influence;
generating a graph comprising the residence location nodes, the daily-activity location nodes, the level crossing nodes, and a set of edges that connect the residence location nodes, the daily-activity location nodes, and the level crossing nodes;
generating, for each level crossing node, a connected component including the residence location nodes, the daily-activity location nodes, and the level crossing nodes, including:
defining one of the level crossing nodes as a root node of a maximum spanning tree and adding the root node to the connected component;
repeating, until all reachable nodes of the graph are included in the connected component:
selecting an edge of the graph that is not in the connected component and has greater flow and is connected to any node added in the connected component, provided that the edge connects to a node that is not yet in the connected component and is not connected to a level crossing node other than the root node;
including the edge in the connected component; and
including the node in the connected component;
and
adding flow values of all edges of the maximum spanning tree formed from the root node to obtain an added value, and assigning said added value to the root node;
and
obtaining a vector comprising the level crossing nodes in a descending order of corresponding added values assigned to each level crossing node.

2. The method of claim 1, wherein the residence location nodes, the daily-activity location nodes, and the level crossing nodes are defined from geographical coordinates or cartographic information.

3. The method of claim 1, wherein defining the residence location nodes, the daily-activity location nodes, and the level crossing nodes includes remote sensing, image analysis, or querying databases.

4. The method of claim 1, wherein a flow value of each edge is defined by an average flow value of individuals between two nodes.

5. The method of claim 1, wherein the maximum spanning tree is determined by a Kruskal algorithm or an adapted Kruskal algorithm.

6. A memory storage medium storing computer-executable instructions for prioritizing railway crossing flows comprising:
defining residence location nodes, daily-activity location nodes, and level crossing nodes within a zone of influence:
generating a graph comprising the residence location nodes, the daily-activity location nodes, the level crossing nodes, and a set of edges that connect the residence location nodes, the daily-activity location nodes, and the level crossing nodes;
generating, for each level crossing node, a connected component including the residence location nodes, the daily-activity location nodes, and the level crossing nodes, including:
defining one of the level crossing nodes as a root node of a maximum spanning tree and adding the root node to the connected component;
repeating, until all reachable nodes of the graph are included in the connected component:
selecting an edge of the graph that is not in the connected component and has greater flow and is connected to any node added in the connected component, provided that the edge connects to a node that is not yet in the connected component and is not connected to a level crossing node other than the root node;
including the edge in the connected component; and
including the node in the connected component; and
adding flow values of all edges of the maximum spanning tree formed from the root node to obtain an added value, and assigning said added value to the root node; and
obtaining a vector comprising the level crossing nodes in a descending order of corresponding added values assigned to each level crossing node.

7. The method of claim 1, wherein each edge in the graph represents an access path or track that connects two nodes, wherein a value of each edge represents flow or distance information of a corresponding represented access path or track.

8. The method of claim 1, wherein each edge in the graph represents a flow that influences a railway crossing and corresponds to an access route.

9. The method of claim 1, wherein the added value assigned to the root node represents a flow associated with the root node and a corresponding risk associated with the root node.

10. The method of claim 1, further comprising:
prioritizing new investments or repairs of the level crossing nodes according to the descending order in the vector.
